(19) United States
(12) Patent Application Publication
(10) Pub. No.: US 2025/0068947 A1
(43) Pub. Date: Feb. 27, 2025

(54) METHODS AND SYSTEMS FOR DIAGNOSING VEHICLE FAULTS BASED ON ENVIRONMENT-ADAPTIVE BAYESIAN NETWORK

(71) Applicant: CAROTA Technology Corporation, Shanghai (CN)

(72) Inventor: Xinjie ZHANG, Shanghai (CN)

(73) Assignee: CAROTA Technology Corporation, Shanghai (CN)

(21) Appl. No.: 18/947,672

(22) Filed: Nov. 14, 2024

(30) Foreign Application Priority Data
Nov. 4, 2024 (CN) 202411562719.4

(51) Int. Cl. G06N 5/046; G07C 5/08

(52) U.S. Cl. CPC G06N 5/046; G07C 5/0808

(57) ABSTRACT

The disclosure provides a method for diagnosing vehicle faults based on an environment-adaptive Bayesian network. The method can comprise receiving an input of a faulty symptom of a vehicle into a vehicle fault detection system; selecting an optimal weighted association fault tree model from a library comprising a plurality of weighted association fault tree models, based on the faulty symptom; mapping the optimal weighted association fault tree model to an environment-adaptive Bayesian network; calculating a credibility of each leaf node within the environment-adaptive Bayesian network; and generating a fault ranking and a fault status information based on the credibility of each leaf node within the environment-adaptive Bayesian network, and initiating a multimedia fault alert. The method for diagnosing vehicle faults demonstrated of the disclosure exhibits remarkable adaptability to varying scenarios and facilitates rapid and accurate diagnosis of vehicle faults, supporting reliable operation and preventive maintenance of vehicles.

### CROSS-REFERENCE TO RELATED APPLICATIONS

This application claims priority to Chinese patent application No. 202411562719.4, filed on Nov. 4, 2024, the contents of which are incorporated herein by reference.

### TECHNICAL FIELD

The disclosure relates generally to automated fault diagnosis for vehicles, particularly to methods and systems for diagnosing vehicle faults based on an environment-adaptive Bayesian network.

### BACKGROUND

The accelerated evolution of automotive technology has led to a notable increase in the intelligence and complexity of modern vehicles. A multitude of electronic control units and sensors are required to manage the critical systems of modern vehicles, including the engine and brakes. This complexity increases the probability of failures, particularly when a plurality of systems interact with one another. Conventional fault detection techniques, including rule-based expert systems and decision tree analysis, frequently prove inadequate for effectively addressing complex faults. These methods are insufficient for the management of interactions between diverse components, resulting in inaccurate diagnoses. Conventional neural network models also encounter difficulties, including prolonged training periods and a proclivity to reach local minima when processing real-time complex data. There is a need for a new fault diagnosis method which integrates system analysis with advanced intelligent algorithms, with the aim of enhancing the accuracy and efficiency of fault detection in complex environments.

### SUMMARY

A first aspect of the disclosure provides a method for diagnosing vehicle faults based on an environment-adaptive Bayesian network. In some embodiments, the method can comprise (S1) receiving an input of a faulty symptom of a vehicle into a vehicle fault detection system; (S2) selecting an optimal weighted association fault tree model from a library comprising a plurality of weighted association fault tree models, based on the faulty symptom; (S3) mapping the optimal weighted association fault tree model to an environment-adaptive Bayesian network; (S4) calculating a credibility of each leaf node within the environment-adaptive Bayesian network; and (S5) generating a fault ranking and a fault status information based on the credibility of each leaf node within the environment-adaptive Bayesian network, and initiating a multimedia fault alert.

A second aspect of the disclosure provides a system comprising one or more computer processors and a computer readable memory. The computer readable memory can comprise machine executable code, which when executed by the one or more computer processors implements the method for diagnosing vehicle faults based on an environment-adaptive Bayesian network.

The method for diagnosing vehicle faults disclosed herein represents a novel integration of a weighted correlation fault tree model with an environment-adaptive Bayesian network. By incorporating correlations between fault severity weights and events within the weighted correlation fault tree model, the method allows for a precise evaluation of the impact each potential fault exerts on the overall system, facilitating the identification and analysis of complex faults. Furthermore, the environment-adaptive Bayesian network dynamically incorporates environmental factors (such as temperature, humidity, and road conditions), enabling the diagnostic system to adjust fault probabilities in real time based on the actual operational context. The adaptive adjustment mechanism enhances the precision and responsiveness of fault diagnosis in complex environments, thereby ensuring the reliability of the diagnostic results. The method for diagnosing vehicle faults demonstrated of the disclosure exhibits remarkable adaptability to varying scenarios and facilitates rapid and accurate diagnosis of vehicle faults, supporting reliable operation and preventive maintenance of vehicles.

### BRIEF DESCRIPTION OF THE DRAWINGS

The novel features of the disclosure are set forth with particularity in the appended claims. A better understanding of the features and advantages of the disclosure will be obtained by reference to the following detailed description that sets forth illustrative embodiments, in which the principles of the disclosure are utilized, and the accompanying drawings.

FIG. 1 is a flow chart of a diagnosing vehicle faults based on an environment-adaptive Bayesian network according to an embodiment of the present application.

FIG. 2 is a flow chart of a method for calculating the credibility of each leaf node in an environment-adaptive Bayesian network according to an embodiment of the present application.

### DETAILED DESCRIPTION

Traditional vehicle fault diagnosis methods primarily rely on standard fault codes, which are generated by the vehicle's electronic control unit (ECU) after a fault occurs. Technicians analyze these fault codes and related log information to determine the root of the fault and perform necessary repairs. However, this code-based diagnostic method has limitations in the range of fault types it can address.

Consequently, this approach is inadequate for addressing the sophisticated fault diagnosis requirements of modern intelligent vehicles.

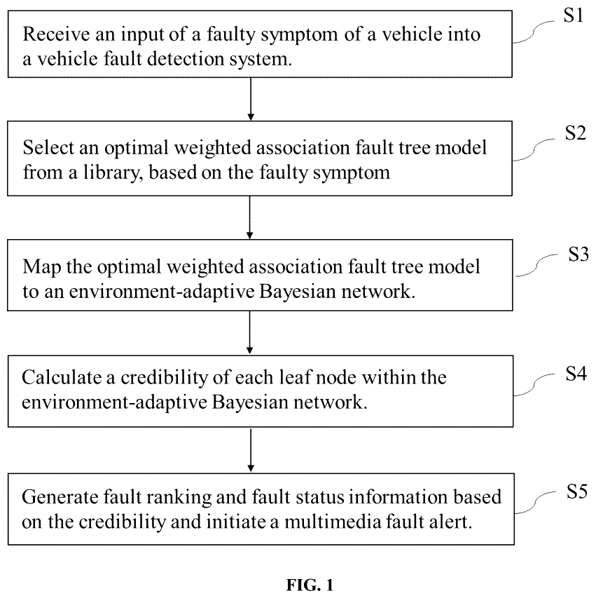

The flow chart of FIG. 1 illustrates a method for diagnosing vehicle faults based on an environment-adaptive Bayesian network, according to an embodiment of the disclosure. In some embodiments, this method can comprise steps S1 to S5. In step S1, faulty symptoms of the vehicle can be input into a vehicle fault detection system. The vehicle fault detection system can be an industrial computer positioned at a car repair center, a handheld detector used by a vehicle maintenance technician, or an intelligent device with remote monitoring capabilities. The vehicle fault detection system can obtain sensor readings directly from the vehicle's sensor system. These sensors can include, but are not limited to, engine sensors, transmission sensors, brake system sensors, electrical system sensors, and suspension system sensors, thereby providing accurate real-time data support. Additionally or alternatively, the vehicle fault detection system can receive the faulty symptoms that are manually entered by a technician or user. This can include data pertaining to abnormalities that are perceived through observation, hearing, or other senses. Examples of faulty symptoms can include, but are not limited to, engine jitter, difficulty in starting the vehicle, transmission shift jams, abnormal transmission noises, increased braking distances, illumination of the electrical system fault light, and abnormal bumps in the suspension system.

In step S2, the detection system can select the optimal weighted association fault tree model from a library comprising a plurality of weighted association fault tree models, based on the faulty symptom input in step S1. In some embodiments, the vehicle fault detection system can first identify key features of the fault symptom. This can be achieved through the analysis of the faulty symptom information, which can include sensor data or manually entered fault descriptions. The feature can comprise information regarding the type of fault, the frequency of occurrence, the severity of the fault, and any correlations with other faults. For example, if the input faulty symptom is “engine jitter”, the system can extract key features, such as engine speed, temperature, and fault codes that are related to the faulty symptom. Subsequently, these features can be input used as to select the optimal weighted association fault tree model from a pre-established library. The model library can be developed based on different vehicle types, fault modes, or operating conditions. Each model within the library can include top events, intermediate events, and basic events, along with the corresponding weights and fault correlations.

In a weighted association fault tree model, each fault mode can be assigned a weight, which indicates the degree of impact on the overall system reliability. By utilizing the matched fault tree model, the system can identify the key nodes and associated fault modes that correspond to the input faulty symptom. For instance, if the faulty symptom is “engine jitter,” the system can match a fault tree model directed to engine-related nodes to facilitate a more detailed analysis of the potential roots of the fault. These may include, for instance, faults in the fuel system, ignition system, or sensors.

In some embodiments, step S2 can comprise extracting and analyzing the features characterizing the faulty symptom. Subsequently, a similarity calculation can be performed to select the weighted association fault tree model with the highest similarity to the features of the faulty symptom from the library comprising a plurality of weighted association fault tree models. The similarity calculation can comprise using a cosine similarity or Euclidean distance.

The method of the disclosure employs a mechanism for selecting the optimal weighted correlation fault tree model based on the features of the faulty symptom. This mechanism enables the identification of the most suitable weighted correlation fault tree model for different faulty symptoms and environmental conditions. This enables the system to more effectively adapt to a range of complex scenarios. The rapid screening of the weighted correlation fault tree model enables the detection system to promptly determine key nodes and potential fault pathways for prioritized investigation, thereby optimizing resource utilization and focusing on probable root causes in subsequent diagnostic steps.

In step S3, the weighted association fault tree model can be mapped to an environment-adaptive Bayesian network. In some embodiments, the top event, intermediate event, and basic event of the weighted association fault tree model correspond to the root node, intermediate node, and leaf node of the environment-adaptive Bayesian network, respectively. This mapping facilitates the construction of a more detailed fault probability model. The top event of the weighted association fault tree model can denote a system failure, whereas the basic event can denote a specific fault that causes that system failure.

The weighted correlation fault tree model can comprise top events, intermediate events, and basic events. To illustrate, consider the case of engine failure. In this instance, the top event can correspond to “engine failure.” The intermediate events can include “insufficient fuel supply,” “ignition failure,” and “overtemperature.” Meanwhile, the basic events can comprise “fuel pump failure,” “spark plug damage,” and “coolant leakage.”

The top event in the weighted association fault tree model can be understood as representing either the overall failure of the system or the final manifestation or outcome of that failure. The top event can be used to aggregate the comprehensive impact of the basic and intermediate events on the system failure. The top event can be mapped to the root node in a Bayesian network. The intermediate events in the fault tree model can be used to denote the failure or functional impairment of a specific subsystem, effectively aggregating the basic events. The intermediate event can be mapped to the intermediate node in the Bayesian network, thereby facilitating the determination of the failure impact path for the subsystem or subcomponent under varying environmental conditions and providing mid-level analytical support. The basic events in the fault tree model can be used to represent specific faults that lead to a system failure. These can include, for example, sensor failure or motor failure. The basic events can be mapped to the leaf nodes in the environment-adaptive Bayesian network. The leaf nodes can be used to reflect the dynamic performance of the underlying fault factors under varying environmental conditions. The leaf nodes can adjust the probability of failure in conjunction with the environmental factor Bi, thereby ensuring that the failure risk associated with each leaf node can be accurately represented under different operational conditions.

In an environment-adaptive Bayesian network, the root node, intermediate node, and leaf node each have distinct meanings. The root node can typically represent the target event of the Bayesian network or the most significant outcome of system, such as an engine failure. The value of the root node can reflect the probability of a range of environmental states (e.g., temperature, humidity, vibration) that may trigger the target event under specific conditions. Such values can provide indispensable context for subsequent calculations. The intermediate node serves as a connection between the root node and the leaf nodes, representing different combinations of events or hierarchical states within the system (e.g., the overall status of various subsystems). The value of the intermediate node can be derived from probability calculations based on the conditions of the root node, indicating the likelihood of the intermediate event occurring under the current environmental conditions. The value of the intermediate node can be derived from the propagation of the root node's value through a conditional probability distribution, which is also known as Bayesian conditioning. The leaf node serves as the terminal node within the Bayesian network, typically representing the state of a specific component or module (e.g., whether it is faulty). The value of the leaf node can indicate the probability of failure of that component in a given environment. The value of the leaf node can be calculated based on the state of the intermediate node and adjusted based on environmental factors. In the context of this disclosure, the term “a failure probability of a leaf node” cab refer to the likelihood of failure in the component that is indicated by the leaf node.

In step S4, a credibility of each leaf node in the environment-adaptive Bayesian network can be calculated. In some embodiments, calculating the credibility of each leaf node in the environment-adaptive Bayesian network may include steps S401-S403.

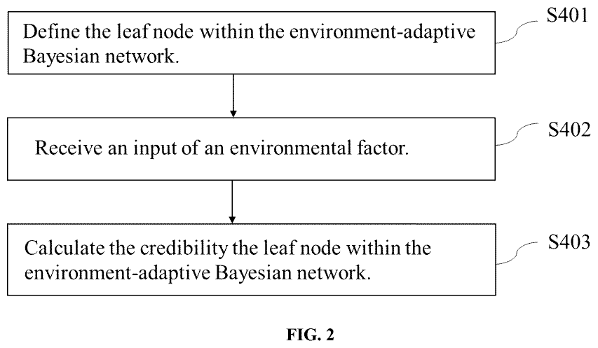

As illustrated in the flow chart of FIG. 2, step S401 can comprise defining the leaf nodes within the environment-adaptive Bayesian network. In the environment-adaptive Bayesian network, leaf nodes can represent specific failure modes or sources of failure. These leaf nodes can be closely linked to the overall system failure state and can be affected by environmental factors. The credibility of each leaf node can indicate the likelihood of its failure under particular environmental conditions.

In step S402, data pertaining to environmental factors can be received. In calculating the credibility of a leaf node, environmental factors (such as real-time environmental parameters including temperature, humidity, and vibration) can be taken into consideration, as these factors have the potential to affect the failure probability of the leaf node. The system can be capable of receiving and processing these environmental data in real time, thereby ensuring the accuracy of the credibility calculation.

In step S403, the credibility Pₖ(T) of a leaf node eᵢ in the environment-adaptive Bayesian network can be calculated using Formula I:

$${P}_{k} ( T ) = \frac{{F}_{1} ( {e}_{i} / T ) \cdot {F}_{2} ( {e}_{i} / T )}{F ( T )} \qquad ( Formula I )$$

where F₁(eᵢ/T) and F₂(eᵢ/T) respectively denote a first fault probability and a second fault probability of the leaf node eᵢ, and F(T) is a system fault probability calculated based on respective fault probabilities of a plurality of leaf nodes within the environment-adaptive Bayesian network. The introduction of parameters related to the failure mode can allow for concise representation of the failure probability of the leaf node eᵢ by the first fault probability F₁(eᵢ/T). This will be discussed in further detail hereinafter with reference to Formula II. The second fault probability F₂(eᵢ/T) can enable a dynamic adjustment of the failure probability by incorporating real-time environmental data as dynamic factors. This approach can allow the fault diagnosis method of the disclosure to respond more flexibly and adaptively to environmental changes, thereby enhancing the accuracy and effectiveness of the diagnosis.

In Formula I, multiplying the first fault probability by the second fault probability can allow the numerator to represent a likelihood of a leaf node failing within a specific environment and operational state. This can effectively quantify the risk of that leaf node failing, particularly when the impact of environmental factors on that leaf node is considered. By dividing this product by F(T), the numerator value can be normalized to a probability value ranging from 0 to 1, representing a relative probability of a specific leaf node failing under the specified environmental conditions.

In some embodiments, the first fault probability F₁(eᵢ/T) can be calculated using Formula II:

$${F}_{1} ( {e}_{i} / T ) = {\sum }_{j = 1}^{{n}_{i}} {γ}_{j} F ( {ω}_{j} ) \qquad ( Formula II )$$

Formula II can represent a cumulative probability of both the normal state and the faulty state of a particular leaf node under all fault mode. This can reflect a fundamental state distribution that is independent of environmental conditions. In Formula II, the state γⱼ of the leaf node eᵢ under the j-th fault mode can be weighted with F(ωⱼ). This can allow for the accumulation of the impact of all fault modes on the fault or normal state of the leaf node eᵢ, as well as the distinguishing and weighting of the impact of each fault mode by the value of γⱼ. In Formula II, the parameter nᵢ is the total number of fault modes associated with the leaf node eᵢ. The parameter γⱼ denotes a state of the leaf node eᵢ under the j-th fault mode, with γⱼ=1 indicating a normal state and γⱼ=0 indicating a faulty state. The parameter w denotes a system state under the j-th fault mode, with ωⱼ=1 indicating a normal state and ωⱼ=0 indicating a faulty state. Parameter F(ωⱼ) is a probability of a faulty state of the system under the j-th fault mode.

In some embodiments, the second fault probability F₂(eᵢ/T) can be calculated using Formula III:

$${F}_{2} ( {e}_{i} / T ) = {\prod }_{i = 1}^{n} [ 1 - {γ}_{i} - {( - 1 )}^{( 1 + {γ}_{i} )} F ( T ) {θ}_{i} ] \qquad ( Formula III )$$

Formula III can represent a comprehensive impact of status of all the leaf nodes on a faulty state of a particular leaf node under real-time environmental condition. The Formula 3 can allow for the adjustment of an interaction impact between the plurality of leaf nodes by incorporating environmental factors and the total failure probability of the system. The multiplication Πᵢ₌₁ⁿ in Formula 3 can comprehensively capture the impact of all the leaf node states on the potential failure of the leaf node eᵢ. The value of γᵢ can be used to present the comprehensive impact of interactions among various leaf nodes on the failure of the leaf node eᵢ. In Formula 3, the parameter n is the total number of leaf nodes in the environment-adaptive Bayesian network. The parameter θᵢ is an environmental factor for adjusting a failure probability of the leaf node eᵢ under environmental changes. The parameter γᵢ denotes a status of the i-th leaf node eᵢ, with γᵢ=1 indicating a normal state and γ_i=0 indicating a faulty state. The Formula III is capable of reflecting the system's dynamic adjustment to the state of the leaf node eᵢ by considering the combined impact of the system fault F(T) and the environmental factor θᵢ. This enables the system to adaptively respond to varying environmental conditions.

Formula IV can be obtained by substituting Formula II and Formula III into Formula I:

$${P}_{k} ( T ) = \frac{{\sum }_{j = 1}^{{n}_{j}} {γ}_{j} F ( {ω}_{j} ) \cdot {\prod }_{i = 1}^{n} [ 1 - {γ}_{i} - {( - 1 )}^{( 1 + {γ}_{i} )} F ( T ) {θ}_{i} ]}{F ( T )} \qquad ( Formula IV )$$

In Formula IV, the term (1−γᵢ) is a state adjustment term. In the event that the leaf node eᵢ is in a normal state (i.e., γᵢ=1), the value of (1−γᵢ) is equal to zero, indicating that a contribution of the normal state to the failure probability is zero. On the other hand, if the leaf node eᵢ is in a faulty state (i.e., γᵢ=0), the value of (1−γᵢ) is equal to one, indicating that a contribution of the normal state to the failure probability is one. In Formula IV, the term (−1)(1+γᵢ)F(T)θᵢ is used to adjust the impact of each leaf node in the context of a system failure. In the event that the leaf node eᵢ is in a normal state (i.e., γᵢ=1), the value of (−1)(1+γᵢ)F(T)θᵢ is equal to one, indicating that the impact of the system failure and environmental factors F(T)θᵢ is subtracted. On the other hand, if the leaf node eᵢ is in a faulty state (i.e., γᵢ=0), the value of (−1)^{(1+γi)}F(T)θᵢ is equal to minus one, indicating that the impact of the system failure and environmental factors F(T)θᵢ is added. Therefore, the numerator

Σⱼ₌ⱼ^{nj}γⱼF(ωⱼ)·Πᵢ₌₁ⁿ[1−γᵢ−(−1)^{(1+γi)}F(T)θᵢ]

in Formula IV can denote a comprehensive failure probability of the leaf node eᵢ under varying environmental conditions, taking into account (i) the cumulative probability of both a normal state and a faulty state of the leaf node eᵢ under each fault mode and (ii) the comprehensive impact of status of all the leaf nodes on a faulty state of the leaf node eᵢ in a real-time environment. The numerator in Formula IV combines the first failure probability (i.e., the failure probability considering parameters pertaining to failure modes) and the second failure probability (i.e., the failure probability considering dynamic environmental factors) of a leaf node, thereby enabling an environment-adaptive fault diagnosis.

In some embodiments, the numerator F(T) in Formula I and Formula IV can be calculated using Formula V:

$$F ( T ) = F ( {e}_{1} ⋃ {e}_{2} … ⋃ {e}_{n} ) = 1 - {\prod }_{i = 1}^{n} ( 1 - {ρ}_{i} \cdot {q}_{i} ) \cdot {\prod }_{j = 1}^{m} ( 1 - P ( {e}_{j} \vert {e}_{i} ) ) \qquad ( Formula V )$$

In Formula V, F(e₁ U e₂ . . . U eᵢ) denotes that a failure probability of a root node (e.g., the system) in the environment-adaptive Bayesian network is calculated based on respective failure probabilities of a plurality of leaf nodes (e.g., e₁, e₂, . . . , eₙ) in the environment-adaptive Bayesian network. In Formula V, the parameter qi is a failure probability of the leaf node eᵢ under current environmental conditions. This is a probability value calculated based on a state of the leaf node and the environmental factors, representing the possibility of failure of the component or module corresponding to the leaf node eᵢ. The parameter ρᵢ is a severity weight of a failure of the leaf node eᵢ, with a range [0, 1]. An increase in the weight value indicates a greater impact of the failure of the leaf node eᵢ on the entire system or root node. This weight allows the model to differentiate between the significance of failures of different leaf nodes, thereby ensuring that the failure of pivotal components has a more significant impact on the overall system. The parameter P(eⱼ|eⱼ) represents an event correlation, indicating the probability of a different leaf node eⱼ failing when the leaf node eᵢ fails. The parameter P(eⱼ|eᵢ) accounts for a correlation between different leaf nodes. For example, if a strong correlation exists between leaf node eᵢ and leaf node eⱼ, the probability of leaf node eⱼ failing when leaf node eᵢ fails is elevated, and vice versa. The parameter m represents the number of different leaf nodes that can be affected by a failure of a given leaf node eᵢ. The parameter m is used to describe a complexity of interaction between leaf nodes, that is, the number of leaf nodes that can be affected in the event of a particular leaf node's failure.

In Formula 5, F(T) can be obtained by calculating the comprehensive impact of the failure probabilities of each leaf node. For example, Formula 5 first assesses the impact of the failure of each leaf node on the overall failure probability by weighting the failure probability qi of each leaf node eᵢ (i.e., multiplying the failure probability qi by the severity weight pi). Subsequently, the event correlation term P(eⱼ|eᵢ) can be introduced to reflect the correlation between leaf nodes. The product result of multiplication of these values can represent a transmission pathway of a fault among different leaf nodes. In Formula V, the overall failure probability of the system (i.e., the root node) can be calculated by subtracting the product result of multiplication of the respective failure probabilities of each leaf node from 1. This approach ensures that in an extreme scenario where the leaf nodes are not correlated (i.e., there is no event correlation term), the overall system failure probability is simply the weighted sum of the respective failure probabilities of each leaf node. In the event of correlations between leaf nodes, the overall system failure probability can be further adjusted based on a strength of the correlation. By integrating the respective failure probabilities of the leaf nodes, the severity weights, and the event correlation, Formula 5 of the disclosure can be capable of calculating the overall failure probability of the system or root node. This calculation method can dynamically adapt to different environmental conditions, accurately reflecting the contribution of leaf node failures to system failures and enhancing the precision of fault prediction and the environmental adaptability of the model.

In some embodiments, the severity weight pi can represent the importance or impact of the leaf node eᵢ on the root node. The severity weight pi can quantify the impact of a failure of a particular leaf node on the reliability or functionality of the overall system. In the event that ρᵢ=0, it can indicate that the impact of the leaf node eᵢ on the system failure can be completely disregarded. In other words, an occurrence of this basic event will not affect the reliability or functionality of the system. In this instance, it can be considered that there is no correlation between the occurrence of this leaf node and the occurrence of system failure. On the other hand, if ρᵢ=1, this can be indicative that the occurrence of the leaf node eᵢ has the most significant impact on the system failure. In this case, the occurrence of the leaf node eᵢ will directly result in the system failure. In the event that ρᵢ has a value between 0 and 1, it can indicate that the leaf node eᵢ exerts a certain impact on the failure probability of the system, yet does not directly cause the system failure. For example, if ρᵢ=0.5, it can indicate that the occurrence of the leaf node eᵢ increases the likelihood of system failure, yet it does not guarantee the occurrence of the system failure.

In some embodiments, the value of the event correlation P(eⱼ|eⱼ) can range between 0 and 1. In the event that P(eⱼ|eᵢ)=0, it can indicate that if the leaf node eᵢ fails, the probability of another leaf node eⱼ failing is zero. In the event that P(eⱼ|eᵢ)=1 it can indicate that if the leaf node eᵢ fails, another leaf node eⱼ also fails. In the event that 0<P(eⱼ|eⱼ)<1, it can indicate that if the leaf node eⱼ fails, there is a certain probability that another leaf node eⱼ also fails, although this failure is not guaranteed.

In the weighted correlation fault tree model, the incorporation of the event correlation P(eⱼ|eⱼ) can enable a systematical analysis of the temporal relationships between faulty events, facilitating a depiction of fault propagation pathways and a deeper comprehension of the root causes of faults. For instance, a failure in the fuel pump can elevate the likelihood of insufficient fuel supply, prompting the system to analyze the failure in fuel pump by considering the correlation between the two events.

Furthermore, the model can quantify the impact of each basic event on the top event (i.e., system failure) by considering the severity weight ρᵢ. For example, a brake fluid leakage in the brake system can be assigned a higher severity weight than a brake pad wear, as a brake fluid leakage directly affects the vehicle's safety. This approach can ensure that the method of the disclosure prioritizes addressing faults with greater impact, thereby enhancing the accuracy and efficacy of fault detection. The concurrent occurrence of an abnormal vibration in the suspension system and a brake fluid leakage can result in a failure of the braking system when driving on slippery roads. The weighted correlation fault tree model can facilitate the prioritization of addressing brake fluid issues by analyzing the impact of the failures in the suspension system on the brake system and incorporating the severity weight of brake fluid leakage. This approach can effectively mitigate the risk of potential brake failure accidents.

In Formulas I and IV, the calculated value can be normalized to a probability by dividing the numerator with the denominator F(T). This probability can range from 0 to 1, representing a relative probability of a particular leaf node failing under given environmental conditions. The denominator F(T) can denote the overall failure probability of the system under given environmental conditions, which serves as a baseline for comparison. A comparison of the numerator (i.e., the failure of a particular leaf node) with the baseline can facilitate the determination of the importance and relative contribution of the leaf node to the overall failure probability of the system. For instance, if the failure probability of a particular leaf node is relatively low in comparison to the overall failure probability of the system, it can indicate that the leaf node has a limited impact on the probability of system failure. On the other hand, if the failure probability of a particular leaf node is high, it can suggest that the leaf node plays a pivotal role in the system's failure.

Furthermore, by dividing the numerator in Formulas I and IV with the denominator F(T), it is possible to evaluate the failure impact of a particular leaf node in the context of the overall system failure risk. This relative evaluation can facilitate the identification of critical failure modes and enable dynamic adjustments. In the process of identifying key failure modes, the calculation of the credibility of each leaf node can reveal which nodes are more likely to cause system failures under given environmental conditions. This information can then be used to inform the maintenance and repair priorities.

In regard to dynamic adjustment, as environmental conditions undergo changes, F(T) also exhibits fluctuations, thereby enabling the credibility of each leaf node to reflect the immediate impact of the current environment on the risk of failure in real time. Furthermore, the incorporation of the denominator F(T) serves to enhance the robustness of the fault diagnosis model. For instance, in different environmental conditions and scenarios, F(T) can be modified in real time to ensure that the model is able to adapt to a range of operational contexts and potential failure modes. This design enhances the system's responsiveness to environmental alterations, facilitating the incorporation of both static data and the impact of evolving environments in the assessment of potential faults.

In step S5, a fault ranking and fault status information can be generated based on the credibility of each leaf node, and a multimedia fault alert can be initiated. In some embodiments, the fault ranking can comprise sorting the leaf nodes in accordance with the risk of failure of each one, based on the calculated credibility Pₖ (T) value for each leaf node in the environment-adaptive Bayesian network. A higher credibility value for a leaf node can indicate a greater likelihood of failure under given environmental conditions. Therefore, the leaf node having higher credibility value can be ranked first. The sorting results can be displayed as a list, which includes the name of the leaf node, its credibility value, and a description of the fault mode. This can facilitate a rapid identification and location of key components that may be experiencing issues. In some embodiments, in addition to ranking, the fault status information for each leaf node can also be output. The fault status information can include, but is not limited to: a current state (e.g., normal or fault), a fault type (e.g., engine fault, transmission system fault), a degree of impact (e.g., assessment of impact on vehicle operation), possible causes of the fault (e.g., derived from analysis of historical data and environmental factors), maintenance suggestions (e.g., recommended repair or information on parts to be replaced, to assist technicians in efficiently resolving issues), or any combination thereof.

In some embodiments, the method of the present disclosure can include the automatic triggering of a multimedia fault alert based on the result of the fault ranking and the credibility. The multimedia fault alerts can comprise audio alerts, visual alerts, mobile phone push notifications, or any combination of these. The alerts can be configured to provide detailed fault warnings, reminders, and emergency notifications at multiple levels. Such multi-level alerts can assist technicians or drivers in taking appropriate measures based on the severity of the fault. The disclosed alert system can dynamically adjust the alert level in response to changing circumstances. For example, in the event that a fault condition is identified as deteriorating, the alert level can be automatically elevated from a lower level to a higher one. Conversely, if the status restored to normal following the rectification of the fault or resolution of the issue, the alert level can be downgraded or eliminated. In the event that a fault is not addressed in a timely manner, the method can provide regular reminders to ensure that issue is given priority during a subsequent maintenance.

In the fault diagnosis method of the disclosure, the fault tree model is first mapped to the environment-adaptive Bayesian network, and potential faults are subsequently calculated with the environment-adaptive Bayesian network. In comparison to methodologies where the potential faults are calculated with the fault tree model, the approach of the disclosure can offer a number of technical advantages.

The environment-adaptive Bayesian network-based fault diagnosis method of the disclosure is capable of effectively handling complex environmental factors, improving dynamic adaptability, and yielding more accurate diagnostic results. The method for diagnosing vehicle faults based on environment-adaptive Bayesian network of the disclosure can be dynamically adapted to environmental factors. The fault tree model is inherently static, thereby imposing constrains on its capacity to reflect the impact of changing external environments on system failures. The environment-adaptive Bayesian network is capable of integrating environmental factors (e.g., temperature, humidity, vibration) in a dynamic manner. It is possible to make automatic adjustment in the environment-adaptive Bayesian network during the calculation of fault probability in order to capture the impact of actual working conditions on potential faults. Once the environmental factors are mapped to the Bayesian network, they can propagate through the nodes, thereby dynamically updating the failure probabilities of both individual nodes and the entire system. Consequently, the environment-adaptive Bayesian network is capable of generating fault analysis results that are more closed aligned with actual working conditions. Furthermore, the method for diagnosing vehicle faults based on environment-adaptive Bayesian network of the disclosure can facilitate a correlation processing between nodes. In the fault tree model, the relationships between nodes are represented by logic gates (such as AND gates, OR gates). Nevertheless, this approach is inadequate for addressing complex associations, particularly in the presence of probabilistic relationships exist between nodes.

Moreover, the method for diagnosing vehicle faults based on environment-adaptive Bayesian network of the disclosure can enable a precise fault reasoning and probability calculation. In a Bayesian network, the complex interdependencies between leaf nodes can be modeled with enhanced flexibility and precision through the use of conditional probability relationships. By leveraging these conditional probabilities, the system is able to analyze the impact of interconnected nodes in great detail, which facilitates the capture and calculation of potential chain failure effects. A fundamental advantage of the Bayesian network is its capacity fir probability-based reasoning. Mapping the fault tree model to a Bayesian network enables the application of Bayesian inference within the network structure to accurately calculate the failure probabilities of leaf nodes and reason from the lower nodes up to the top nodes. In calculating the potential faults, the Bayesian network can update the probability of unknown events based on known conditions. This approach permits the dynamic adjustment of fault probabilities using observed data (such as symptoms of failure), thereby facilitating more accurate inferences of potential faults.

Furthermore, the fault diagnosis method based on environment-adaptive Bayesian network of the disclosure is capable of accommodating uncertainty and facilitating real-time updates. In complex vehicle systems, fault data frequently exhibit some degree of uncertainty or ambiguity, such as sensor noise or data loss that results in incomplete information. The Bayesian network's probabilistic model is designed to address this issue, providing a robust framework for fault inference. The Bayesian network framework permits real-time updates, thereby facilitating continuous adjustment of node probabilities as new data (such as real-time environmental monitoring or system status data) are inputted. This capability enables effective real-time fault diagnosis. Moreover, the fault diagnosis method based on environment-adaptive Bayesian network of the disclosure can serve to enhance diagnostic accuracy and system adaptability. The mapping of the fault tree model to the environment-adaptive Bayesian network can enable the system to adapt dynamically in accordance with real-time conditions, thereby enhancing the model's diagnostic precision and adaptability in complex, dynamic environments. This advancement is of particular significance for enhancing diagnostic efficiency, reducing the occurrence of false positives and missed detections, and optimizing maintenance decisions. In scenarios involving intelligent or remote monitoring, it can markedly enhance overall system performance.

### Example

In an exemplary embodiment, it is assumed that the vehicle braking system exhibits a faulty symptom of “increased braking distance.” The vehicle fault diagnosis method based on environment-adaptive Bayesian network of the disclosure can include steps S1-S5. In step S1, the vehicle maintenance technician or vehicle monitoring system can input the faulty symptom of “increased braking distance” into the vehicle fault detection system. Additionally, data from vehicle sensors, such as brake pad thickness, brake fluid level, and master cylinder pressure, can be input into the system. In step S2, upon receiving the faulty symptom of “increased braking distance,” the vehicle fault detection system can match the faulty symptom with models from a library of weighted association fault tree models. By extracting and analyzing the features of the faulty symptom and performing similarity calculations, the vehicle fault detection system can determine the best match, which in this case can be the “brake system fault tree model.” This “brake system fault tree model” can comprise a set of potential causes for the fault and hierarchical event relationships related to braking, which are assigned severity weights to quantify the impact of each potential fault. For example, the “brake system fault tree model” can include:
Top event: Brake system failure (e.g., overall reduction in braking effectiveness, leading to increased braking distance).
Intermediate events: issues such as insufficient brake fluid, brake pad wear, and master cylinder failure.
Basic events: specific faults, including brake fluid level sensor failure and inadequate brake pad thickness.

In step S3, the “brake system fault tree model” can be mapped to the environment-adaptive Bayesian network. The environment-adaptive Bayesian network can include:
Root node: brake system failure.
Intermediate nodes the main components of the brake system, such as brake fluid, brake pads, and the master cylinder.
Leaf nodes: specific detection points, including brake fluid level, brake pad thickness, and air volume in the brake system, which represent different faulty states of each component.

In step S4, the probability of each leaf node failing under the current environment, that is, the credibility Pₖ (T) of the leaf node under specific environmental conditions (such as temperature, humidity, etc.), can be calculated. This calculation can be performed using Formula IV:

$${P}_{k} ( T ) = \frac{{F}_{1} ( {e}_{i} / T ) \cdot {F}_{2} ( {e}_{i} / T )}{F ( T )} = \frac{{\sum }_{j = 1}^{{n}_{j}} {γ}_{j} F ( {ω}_{j} ) \cdot {\prod }_{i = 1}^{n} [ 1 - {γ}_{i} - {( - 1 )}^{( 1 + {γ}_{i} )} F ( T ) {θ}_{i} ]}{F ( T )} \qquad ( Formula IV )$$

Assuming that insufficient brake pad thickness is represented as leaf node eᵢ and insufficient brake fluid is represented as leaf node e₂, the calculation of credibility of a leaf node is as follows.

1. Determine the system failure probability F(ωⱼ) and leaf node state parameter γⱼ.

Define the leaf node state parameter γ₁ to represent the operating state of the leaf node eᵢ under each fault mode. If the leaf node operates normally under the j-th fault mode, then γ₁=1. If the leaf node fails under the j-th fault mode, then γ₁=0. For instance, in the context of the “increased braking distance” issue, if the fault is attributed to insufficient brake fluid in a particular fault mode, then the leaf node associated with the brake fluid has γ₁=0, while the leaf node associated with the brake pad thickness has γⱼ=1.

F(ωⱼ) represents the probability of system failure under the j-th fault mode. For instance, in a low-temperature and high-humidity environment, the viscosity of the brake fluid may increase, thereby elevating the likelihood of brake failure in the system. Assuming that F(ωⱼ)=0.6 under this fault mode, it can indicate that the probability of system failure under these environmental conditions is 60%.

2. Calculate the first fault probability

Σⱼ₌₁ⁿⁱγⱼF(ωⱼ)

of the leaf node eᵢ probability of the first failure of the leaf node eᵢ.

The probability of the first fault of the leaf node eᵢ represents the cumulative probability of both the normal states and the faulty states of the leaf node eᵢ under all fault modes. This can reflect a fundamental state distribution that is independent of environmental conditions.

The impact of all fault modes on the fault or normal state of the leaf node eᵢ is accumulated. The impact of each fault mode on the leaf node eᵢ is distinguished and weighted by the value of γⱼ.

3. Calculate the second fault probability

Πᵢ₌₁ⁿ[1−γᵢ−(−1)^{(1+γi)}F(T)θᵢ]

of the leaf node eᵢ.

The second fault probability

Πᵢ₌₁ⁿ[1−γᵢ−(−1)^{(1+γi)}F(T)θᵢ]

can represents a comprehensive impact of status of all the leaf nodes on a faulty state of the leaf node eᵢ under real-time environmental condition.

(3.1) Determine the impact

[1−γᵢ−(−1)^{(1+γi)}F(T)θᵢ]

of each leaf node in the system on the state of the leaf node eᵢ in a real-time environment.

The term (1−γᵢ) is a state adjustment term. In the event that the leaf node eᵢ is in a normal state (i.e., γᵢ=1), the value of (1−γᵢ) is equal to zero, indicating that a contribution of the normal state to the failure probability is zero. On the other hand, if the leaf node eᵢ is in a faulty state (i.e., γᵢ=0), the value of (1−γᵢ) is equal to one, indicating that a contribution of the normal state to the failure probability is one. The term (−1)(1+γᵢ)F(T)θᵢ is used to adjust the impact of each leaf node in the context of a system failure. In the event that the leaf node eᵢ is in a normal state (i.e., γᵢ=1), the value of (−1)^{(1+γi)}F(T)θᵢ is equal to one, indicating that the impact of the system failure and environmental factors F(T)θᵢ is subtracted. On the other hand, if the leaf node eᵢ is in a faulty state (i.e., γᵢ=0), the value of (−1)^{(1+γi)}F(T)θᵢ is equal to minus one, indicating that the impact of the system failure and environmental factors F(T)θᵢ is added.

(3.2) Use multiplication Πᵢ₌₁ⁿ to comprehensively capture the impact of all the leaf node states on the potential failure of the leaf node eᵢ.

The impact of all the leaf node states on the potential failure of the leaf node eᵢ can be comprehensively captured by multiplying the associated impacts of each leaf node.

4. Calculate the numerator

Σⱼ₌₁ⁿγⱼF(ωⱼ)·Πᵢ₌₁ⁿ[1−γᵢ−(−1)^{(1γi)}F(T)θᵢ].

Under changing environmental conditions, the comprehensive failure probability of a specific leaf node eᵢ can be calculated by taking into account (i) a cumulative probability of both a normal state and a faulty state of the leaf node eᵢ under all fault mode and (ii) a comprehensive impact of status of all the leaf nodes on a faulty state of the leaf node eᵢ under real-time environmental condition.

5. Calculate the denominator F(T).

The denominator F(T) can represent the overall failure probability of the entire system under current environmental conditions. It can be determined by the failure probabilities of all leaf nodes impacted by various environmental factors. The denominator F(T) can be used to normalize the numerator to ensure that the credibility Pₖ(T) is expressed as a probability within the range [0, 1].

The numerator F(T) can be calculated using Formula V:

$$F ( T ) = F ( {e}_{1} ⋃ {e}_{2} … ⋃ {e}_{n} ) = 1 - {\prod }_{i = 1}^{n} ( 1 - {ρ}_{i} \cdot {q}_{i} ) \cdot {\prod }_{j = 1}^{m} ( 1 - P ( {e}_{j} \vert {e}_{i} ) ) \qquad ( Formula V )$$

(5.1) Calculate the failure weight and probability of leaf nodes

Πᵢ₌₁ⁿ(1−ρᵢ·qᵢ).

In this term, qᵢ is a failure probability of the leaf node eᵢ, and ρᵢ is a severity weight of a failure of the leaf node eᵢ, with a range [0, 1], indicating the degree of impact of the leaf node on the overall failure of the system. The probability that node eᵢ does not fail when the system is operating normally is calculated by (1−ρᵢ−qᵢ). By taking the product of these probabilities across all leaf nodes, the overall probability that the system remains normal when all leaf nodes are either in a normal state or experiencing faults.

(5.2) Calculate the fault correlation between nodes

Πⱼ₌₁^{m}(1−P(eⱼ|eᵢ)).

P(eⱼ|eⱼ) represents an event correlation, indicating the probability of a different leaf node eⱼ failing when the leaf node eᵢ fails. By calculating (1−P(eⱼ|eᵢ)), the probability that correlated nodes do not fail when node eᵢ fails can be obtained.

Taking the product

Πⱼ₌₁^{m}(1−P(eⱼ|eᵢ))

over all correlated nodes can provide the probability that the system remains normal even when multiple nodes fail.

(5.3) Inversion of overall system failure probability.

Subtracting the above product term from 1, i.e.,

1−Πᵢ₌₁ⁿ(1−ρᵢ·qᵢ)·Πⱼ₌₁^{m}(1−P(eⱼ|eᵢ)),

can yield the failure probability of the system F(T) under the comprehensive impact of leaf node failures.

This calculation allows F(T) to effectively integrate the individual leaf node failure probabilities, the failure impact weights, and the correlations between node failures to determine the overall system failure probability, which is used to calculate the credibility of each leaf node in the subsequent calculation.

6. Calculate the credibility Pₖ (T).

By dividing the numerator by the denominator F(T), the credibility Pₖ(T) of the failure of each leaf node in the current environment can be obtained. For example, if Pₖ (T)=0.85, it can indicate that the credibility of the failure of the leaf node eᵢ under the current environmental conditions is 85%. This can suggest that the failure probability of the leaf node in the current environment is significant and should be prioritized for inspection.

Through the above calculations, the vehicle fault diagnosis method based on the environment-adaptive Bayesian network of the disclosure can determine the credibility of each leaf node based on the fault impact under varying environmental factors. This provides data support for further fault prioritization and alert generation.

In step S5, based on the calculated credibility Pₖ(T) of each leaf node, the system can determine the fault ranking for the symptom of “increased braking distance”.

For example, the ranking results can be as follows:
Insufficient brake fluid (highest credibility, prioritize for inspection)
Brake pad wear
Master cylinder anomaly

Based on this ranking, the fault status information can be generated, and drivers or maintenance personnel can be notified via multimedia alerts. Alert information can be displayed hierarchically as follows:
Level 1 Alert: High priority (e.g., low brake fluid). This alert can include audio and visual indicators such as warning lights that display the message: “Brake system fault detected. Immediate brake fluid level check is recommended.”
Level 2 Alert: Medium priority (e.g., brake pad wear). The display can show a message “Possible brake pad wear detected. Service is recommended at the earliest opportunity.”

The disclosure also provides a system including one or more computer processors and a computer readable memory. The computer readable memory can include machine executable code, which implements the method for diagnosing vehicle faults based on an environment-adaptive Bayesian network of the disclosure.

While preferred embodiments of the present invention have been shown and described herein, it will be obvious to those skilled in the art that such embodiments are provided by way of example only. Numerous variations, changes, and substitutions will occur to those skilled in the art without departing from the invention.

What is claimed is:

1. A method for diagnosing vehicle faults based on an environment-adaptive Bayesian network, the method comprising:
(S1) receiving an input of a faulty symptom of a vehicle into a vehicle fault detection system;
(S2) selecting an optimal weighted association fault tree model from a library comprising a plurality of weighted association fault tree models, based on the faulty symptom;
(S3) mapping the optimal weighted association fault tree model to an environment-adaptive Bayesian network;
(S4) calculating a credibility of each leaf node within the environment-adaptive Bayesian network; and
(S5) generating a fault ranking and a fault status information based on the credibility of each leaf node within the environment-adaptive Bayesian network and initiating a multimedia fault alert.

2. The method of claim 1, wherein step (S2) comprises:
(S201) extracting and analyzing a feature of the faulty symptom; and
(S202) selecting, through a similarity calculation, a weighted association fault tree model with the highest similarity with the feature of the faulty symptom from the library comprising a plurality of weighted association fault tree models as the optimal weighted association fault tree model.

3. The method of claim 2, wherein the similarity calculation comprises using a cosine similarity or a Euclidean distance.

4. The method of claim 1, wherein step (S4) comprises:
(S401) defining the leaf node within the environment-adaptive Bayesian network, the leaf node representing a fault mode or a fault source;
(S402) receiving an input of an environmental factor, the environmental factor comprising a real-time environmental parameter; and
(S403) calculating the credibility Pₖ(T) of the leaf node eᵢ within the environment-adaptive Bayesian network using Formula I:
$${P}_{k} ( T ) = \frac{{F}_{1} ( {e}_{i} / T ) \cdot {F}_{2} ( {e}_{i} / T )}{F ( T )} \qquad ( Formula I )$$
where F₁(eᵢ/T) is a first fault probability of the leaf node eᵢ, F₂(eᵢ/T) is a second fault probability of the leaf node eᵢ, and F(T) is a system fault probability calculated based on respective fault probabilities of a plurality of leaf nodes within the environment-adaptive Bayesian network.

5. The method of claim 4, wherein F₁(eᵢ/T) is calculated using Formula II:
$${F}_{1} ( {e}_{i} / T ) = {\sum }_{j = 1}^{{n}_{i}} {γ}_{j} F ( {ω}_{j} ) \qquad ( Formula II )$$
wherein Formula II represents a cumulative probability of both a normal state and a faulty state of the leaf node eᵢ under all fault mode,
where nᵢ is a total number of fault modes associated with the leaf node eᵢ;
γ₁ denotes a state of the leaf node eᵢ under the j-th fault mode, with γ₁=1 indicating a normal state and γⱼ=0 indicating a faulty state; ω₁ denotes a system state under the j-th fault mode, with ωⱼ=1 indicating a normal state and ωⱼ=0 indicating a faulty state; and F(ωⱼ) is a probability of a faulty state of the system under the j-th fault mode.

6. The method of claim 5, wherein F₂(eᵢ/T) is calculated using Formula III:
$${F}_{2} ( {e}_{i} / T ) = {\prod }_{i = 1}^{n} [ 1 - {γ}_{i} - {( - 1 )}^{( 1 + {γ}_{i} )} F ( T ) {θ}_{i} ] \qquad ( Formula III )$$
wherein Formula III represents a comprehensive impact of status of all the leaf nodes on a faulty state of the leaf node eᵢ under real-time environmental condition,
where n is a total number of leaf nodes in the environment-adaptive Bayesian network, θᵢ is an environmental factor for adjusting a failure probability of the leaf node eᵢ under environmental changes; and γᵢ denotes a status of the i-th leaf node eᵢ, with γᵢ=1 indicating a normal state and γᵢ=0 indicating a faulty state.

7. The method of claim 6, wherein step (S4) comprises calculating the credibility Pₖ(T) of the leaf node eᵢ in the environment-adaptive Bayesian network using Formula IV:
$${P}_{k} ( T ) = \frac{{\sum }_{j = 1}^{{n}_{j}} {γ}_{j} F ( {ω}_{j} ) \cdot {\prod }_{i = 1}^{n} [ 1 - {γ}_{i} - {( - 1 )}^{( 1 + {γ}_{i} )} F ( T ) {θ}_{i} ]}{F ( T )} \qquad ( Formula IV )$$
where
Σⱼ₌₁^{nj}γⱼF(ωⱼ)·Πᵢ₌₁ⁿ[1−γᵢ−(−1)^{(1+γi)}F(T)θᵢ]
denotes a comprehensive failure probability of the leaf node eᵢ under varying environmental conditions, taking into account (i) the cumulative probability of both a normal state and a faulty state of the leaf node eᵢ under each fault mode and (ii) the comprehensive impact of status of all the leaf nodes on a faulty state of the leaf node eᵢ in a real-time environment.

8. The method of claim 4, wherein F(T) is calculated using Formula V:
$$F ( T ) = F ( {e}_{1} ⋃ {e}_{2} … ⋃ {e}_{n} ) = 1 - {\prod }_{i = 1}^{n} ( 1 - {ρ}_{i} \cdot {q}_{i} ) \cdot {\prod }_{j = 1}^{m} ( 1 - P ( {e}_{j} \vert {e}_{i} ) ) \qquad ( Formula V )$$
where F(e₁ U e₂ . . . U eᵢ) denotes a failure probability of a root node in the environment-adaptive Bayesian network being calculated based on respective failure probabilities of a plurality of leaf nodes eᵢ, e₂, . . . , eₙ in the environment-adaptive Bayesian network; qᵢ is a failure probability of the leaf node eᵢ; ρᵢ is a severity weight of a failure of the leaf node eᵢ, with a range [0, 1]; P(e₁|eⱼ) is an event correlation describing a probability that a different leaf node eⱼ fails when the leaf node eᵢ fails; and m is a number of different leaf nodes affected by a failure of the leaf node eᵢ.

9. The method of claim 2, wherein step (S3) comprises mapping a top event, an intermediate event and a basic event of the weighted association fault tree model to a root node, an intermediate node and a leaf node of the environment-adaptive Bayesian network, respectively, wherein the top event of the weighted association fault tree model denotes a system failure, and the basic event of the weighted association fault tree model denotes a fault that causes the system failure.

10. The method of claim 1, wherein step (S5) comprises presenting the fault ranking in a form of a list that includes a name of the leaf node, the credibility and a description of the fault mode.

11. The method of claim 1, wherein the multimedia fault alert in step (S5) comprises a multi-level alert.

12. A system comprising one or more computer processors and a computer readable memory, the computer readable memory comprising machine executable code, which when executed by the one or more computer processors implements the method for diagnosing vehicle faults based on an environment-adaptive Bayesian network of claim 1.
